(19) United States
(12) Patent Application Publication
(10) Pub. No.: US 2011/0166747 A1
(43) Pub. Date: Jul. 7, 2011

(54) System And Method For Controlling Temperature In An Automotive Vehicle

(75) Inventors: Halim Wijaya, Canton, MI (US); Christopher Stephen Van Auken, Canton, MI (US); Kenneth Gerard Brown, Shelby Township, MI (US)

(73) Assignee: FORD GLOBAL TECHNOLOGIES, LLC, Dearborn, MI (US)

(21) Appl. No.: 12/695,429

(22) Filed: Jan. 28, 2010

(51) Int. Cl. B60H 1/00

(52) U.S. Cl. 701/36; 165/203

(57) ABSTRACT

A system and method is provided for controlling temperature in an automotive vehicle having a driver-side area, a front passenger-side area, and a climate control system with at least one interface. The interface allows a user to select a driver-side temperature setting and a passenger-side temperature setting. The system includes a seat occupancy sensor and at least one computer-based controller. In operation, the seat occupancy sensor generates a sensor signal indicative of passenger seat occupancy in the passenger-side area of the vehicle. Based on the sensor signal, the controller controls the climate control system. When the passenger-side area is unoccupied, the climate control system distributes conditioned air according to the driver-side temperature setting to both the driver-side and passenger-side areas.

### BACKGROUND

1. Technical Field

System and method for controlling temperature in an automotive vehicle.

2. Background Art

The need to reduce energy usage in an automotive vehicle is well known. A number of systems in the vehicle use energy to operate. For example, an electric compressor of an air conditioning system uses electric energy to cool the interior of the vehicle. However, many of these systems unnecessarily use energy during operation. For example, it may be unnecessary to use energy to cool air for the passenger-side area of the vehicle when no passenger is present in the passenger-side area.

### SUMMARY

A system and method is provided for controlling temperature in an automotive vehicle having a driver-side area, a front passenger-side area, and a climate control system with at least one interface. The interface allows a user to select a driver-side temperature setting and a passenger-side temperature setting.

The system includes a seat occupancy sensor and at least one computer-based controller. The seat occupancy sensor is at the front passenger-side area of the vehicle. In operation, the seat occupancy sensor generates a sensor signal indicative of passenger seat occupancy in the passenger-side area of the vehicle. Based on the sensor signal from the seat occupancy sensor, the controller responds by executing software instructions stored in computer memory to control the climate control system of the vehicle. The climate control system distributes conditioned air according to the driver-side temperature setting to both the driver-side and passenger-side areas when the passenger-side area is unoccupied. The controller may control the climate control system to distribute conditioned air to the passenger-side area independent of the passenger-side temperature setting when the controller determines that the passenger-side area is unoccupied. Furthermore, the controller may be configured to change the passenger-side temperature setting to the driver-side temperature setting to control the climate control system to distribute air at a single temperature to both the driver-side and passenger-side areas in an effort to achieve the driver-side temperature setting at both the driver-side and passenger-side areas.

The method of controlling temperature in an automotive vehicle includes receiving a sensor signal that indicates passenger seat occupancy in the passenger-side area and determining the passenger seat occupancy based on the sensor signal. Furthermore, the method includes generating at least one control signal based on the passenger seat occupancy. When the passenger seat occupancy indicates that the passenger-side area is unoccupied, the control signal is used to control distribution of conditioned air according to a driver-side temperature setting to both the driver-side and passenger-side areas of the vehicle.

### BRIEF DESCRIPTION OF THE DRAWINGS

FIG. 1 is a fragmentary perspective view schematically illustrating an automotive vehicle having a driver-side area, a passenger-side area, and a system for controlling temperature in the areas;

FIG. 2 is a schematic diagram illustrating an interface to allow a user to select temperature settings for the driver-side and passenger-side areas of the vehicle;

FIG. 3 is a schematic diagram illustrating the vehicle having a climate control system and the system including a seat occupancy sensor at the passenger-side area of the vehicle and at least one computer-based controller to control the climate control system of the vehicle; and

FIG. 4 is a flowchart diagram illustrating a method of controlling temperature in an automotive vehicle having a driver-side area and a passenger-side area.

### DETAILED DESCRIPTION

Embodiments of the present invention generally comprise a system and method for controlling temperature in an automotive vehicle having a driver-side area, a front passenger-side area, and a climate control system with at least one interface. The interface allows a user of the vehicle to control the climate control system. For example, the interface allows the user to select a driver-side temperature setting for the driver-side area as well as a passenger-side temperature setting for the passenger-side area.

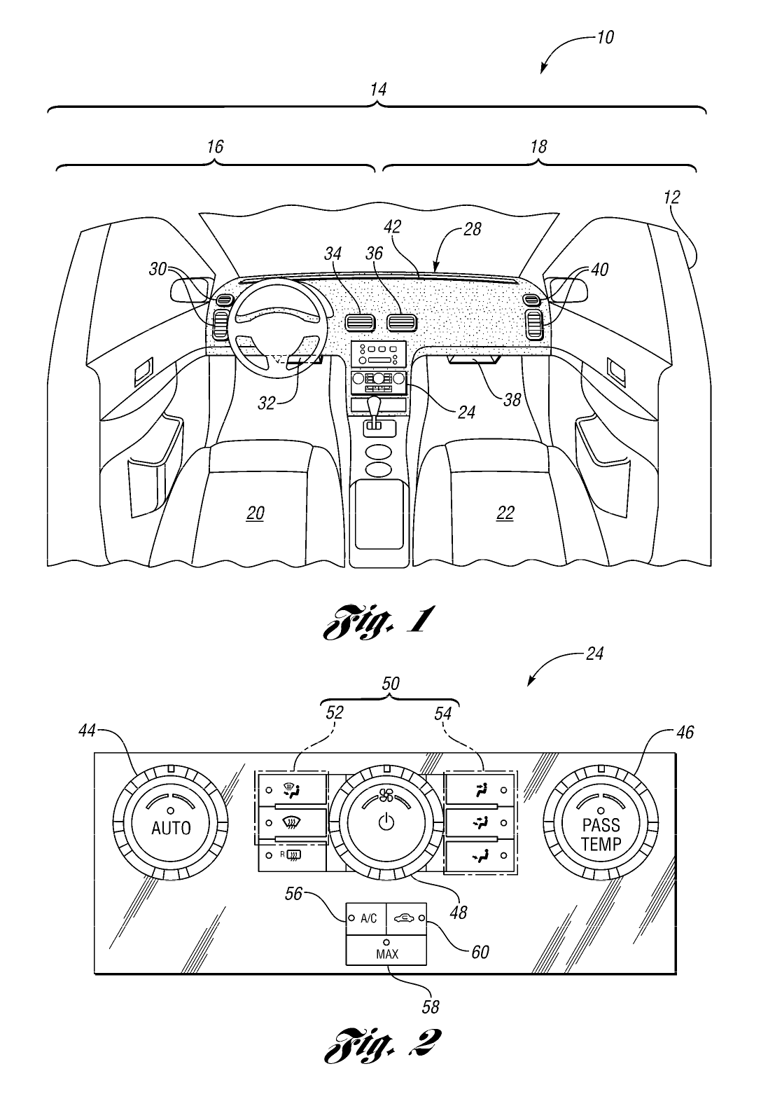

With reference to FIG. 1, a system 10 is generally provided for controlling temperature in an automotive vehicle 12. The temperature in the vehicle 12 may be controlled in an effort to reduce or minimize energy usage of the vehicle 12. Reducing energy usage can include reducing fuel consumed by the vehicle 12, reducing electric energy used by the vehicle 12, or a combination thereof depending on the type of vehicle 12. The system 10 and its method of operation are described in a general fashion to facilitate understanding of various aspects of the present invention.

As illustrated in FIG. 1, the vehicle 12 has a cabin compartment 14 defining a driver-side area 16 and a front passenger-side area 18. As shown, the driver-side area 16 generally refers to space in the cabin compartment 14 where a driver of the vehicle 12 that is seated in a driver seat 20 can occupy the vehicle 12. For example, the driver-side area 16 includes the three-dimensional space in the cabin compartment 14 above the driver seat 20. Furthermore, the passenger-side area 18 generally refers to space in the cabin compartment 14 where a passenger who is seated in a passenger seat 22 can occupy the vehicle 12. For example, the passenger-side area 18 includes the three-dimensional space in the cabin compartment 14 above the passenger seat 22.

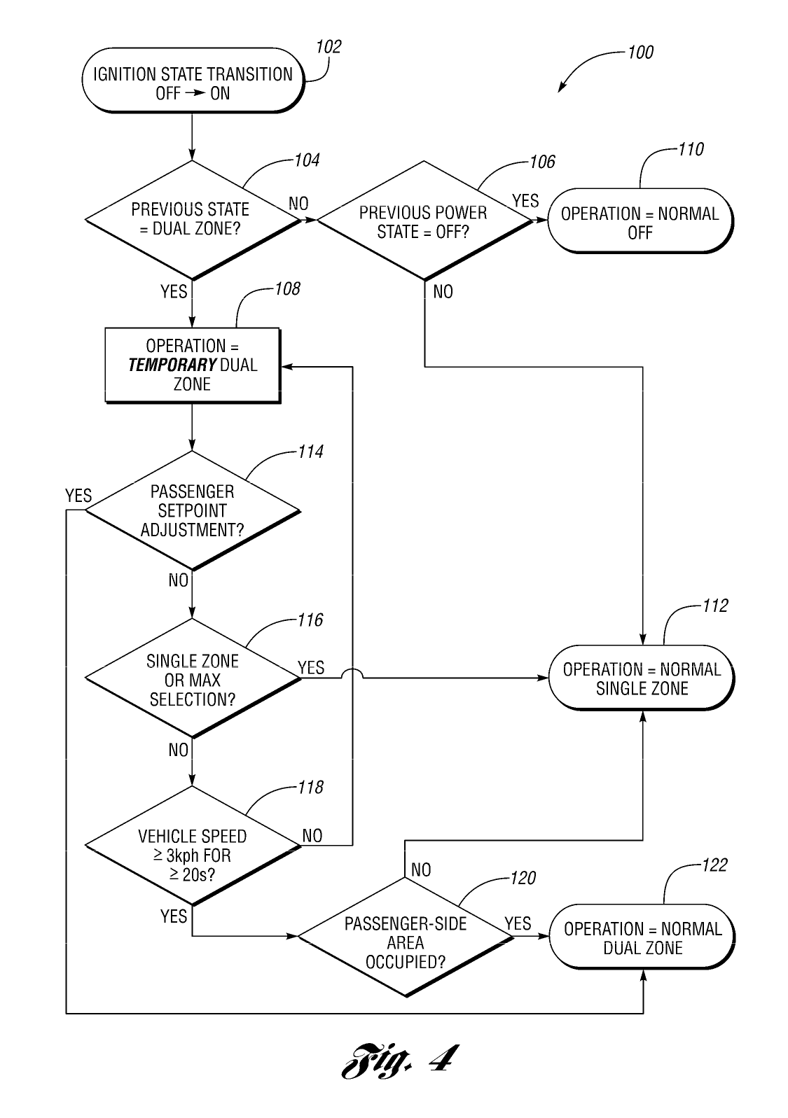

As shown in FIG. 1, the vehicle 12 includes at least one interface 24 for a climate control system 26 (shown in FIG. 3). The interface 24 allows at least one user of the vehicle 12 to control the climate control system 26. The user of the vehicle 12 can be the driver of the vehicle 12, the passenger seated in the passenger seat 22, or both. The interface 24 allows the user to select a driver-side temperature setting for the driver-side area 16 as well as a passenger-side temperature setting for the passenger-side area 18. In addition, the interface 24 may be configured to allow the user to select between a single-zone mode setting and dual-zone mode setting for the climate control system 26.

The climate control system 26 can have a single-zone mode and a dual-zone mode. As used herein, “conditioned air” refers to cooled air, heated air, or both cooled and heated air depending on the operation of the climate control system 26. In the single-zone mode, the climate control system 26 distributes conditioned air to cabin compartment 14 with the driver-side and passenger-side areas 16, 18 collectively representing a single zone that receives conditioned air to achieve a single temperature. In the dual-zone mode, the climate control system 26 delivers conditioned air to the cabin compartment 14, but the driver-side and passenger-side areas 16, 18 represent two different zones or areas of temperature control. In the dual-zone mode, the climate control system 26 delivers conditioned air to the driver-side area 16 according to the driver-side temperature setting and to the passenger-side area 18 based on the passenger-side temperature setting. Thus, the dual-zone mode allows the cabin compartment 14 to achieve a temperature difference between the driver-side and passenger-side areas 16, 18 when the driver-side and passenger-side temperature settings are different.

The climate control system 26 can increase or decrease the temperature of conditioned air flowing to the cabin compartment 14 depending on how the climate control system 26 is commanded to operate. Furthermore, the climate control system 26 controls temperature distribution of conditioned air between the driver-side and passenger-side areas 16, 18. For example, the climate control system 26 may distribute cooler air to the driver-side area 16 than to the passenger-side area 18.

Referring again to FIG. 1, the vehicle 12 includes a number of air ducts 28 (also shown in FIG. 3). The air ducts 28 pass the conditioned air from the climate control system 26 (shown in FIG. 3), through one or more air vents, and to the cabin compartment 14.

The air vents of FIG. 1 include a driver panel vent 30, a driver floor vent 32, a left instrument panel vent 34, a right instrument panel vent 36, a passenger floor vent 38, a passenger panel vent 40, and a defroster vent 42. However, the vehicle 12 may include other vents. The air vents 30, 32, 34, 36, 38, 40, 42 receive conditioned air from the climate control system 26 via the ducts 28 and direct the conditioned air toward the cabin compartment 14. More specifically, the driver panel vent 30 and the driver floor vent 32 are used to pass conditioned air to the driver-side area 16. Likewise, the passenger floor vent 38 and the passenger panel vent 40 are used to pass conditioned air to the passenger-side area 18. The left and right instrument panel vents 34, 36 can be used to pass conditioned air to the driver-side area 16, the passenger-side area 18, or both depending on the directional orientation of the instrument panel vents 34, 36. The defroster vent 42 passes conditioned air to the driver-side and passenger-side areas 16, 18.

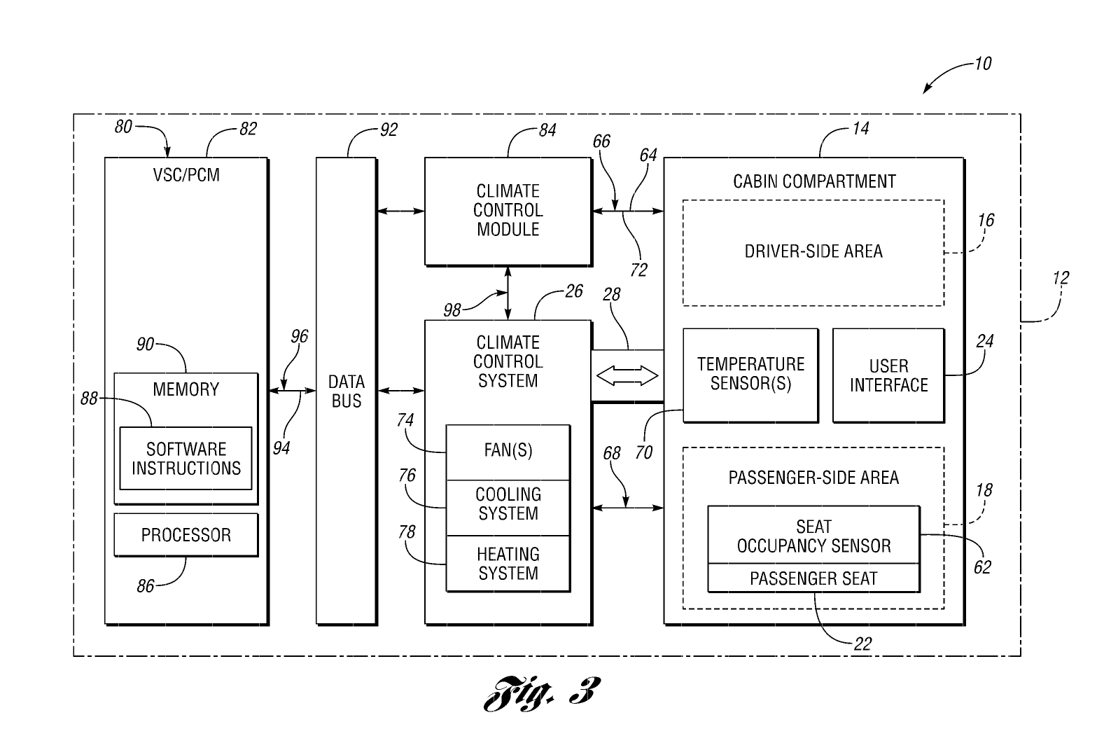

With reference to FIG. 2, the interface 24 includes an auto/driver input control 44 and a passenger input control 46. The auto/driver input control 44 allows the user to input or select a driver-side temperature setting for the driver-side area 16. For example, the user may rotate the auto/driver input control 44 clockwise to increase the temperature setting and counterclockwise to decrease the temperature setting for the driver-side area 16. Based on the driver-side temperature setting, the climate control system 26 will distribute heated or cooled air to the driver-side area 16 until a desired temperature is reached in the driver-side area 16. In addition, the auto/driver input control 44 can be used to control heated or cooled air to the passenger-side area 18 when the passenger input control 46 is disengaged or when the passenger-side area 18 is unoccupied. Thus, the auto/driver input control 44 may control the temperature in the passenger-side area 18 if a passenger is not present in the passenger-side area 18. In addition, the auto/driver input control 44 can allow the user to select a temperature setting for the driver-side and passenger-side areas 16, 18 when the climate control system 26 is in the single-zone mode.

With continuing reference to FIG. 2, the passenger input control 46 allows the user to input or select a passenger-side temperature setting for the passenger-side area 18. The user can engage or disengage the passenger input control 46. For example, the user may engage or disengage the passenger input control 46 by pressing the control 46. In addition, the user may rotate the passenger input control 46 clockwise to increase the passenger-side temperature setting and counterclockwise to decrease the passenger-side temperature setting for the climate control system 26.

The passenger input control 46 of the interface 24 can allow the user to select between the single-zone mode and dual-zone mode of the climate control system 26. For example, the climate control system 26 switches from the dual-zone mode to the single-zone mode when the climate control system 26 is operating in a dual-zone mode and a user presses the passenger input control 46. In another example, the climate control system 26 switches from the single-zone mode to the dual-zone mode when the climate control system 26 is operating in a single-zone mode and the user presses the passenger input control 46.

As shown in FIG. 2, the interface 24 may include a power input control 48. The user can operate the power input control 48 to switch the climate control system 26 between an off mode and an on mode. When the climate control system 26 is in the off mode, conditioned air is not distributed from the climate control system 26 to the cabin compartment 14. When the climate control system 26 is in the on mode, the user may adjust the fan speed of the climate control system 26. For example, the user may rotate the power input control 48 clockwise to increase the fan speed and counterclockwise to decrease the fan speed.

As illustrated in FIG. 2, the interface 24 includes vent input controls 50. The vent input controls 50 include defrost controls 52 and non-defrost controls 54. The user can operate the defrost controls 52 to control distribution of conditioned air between the defroster vent 42 and the driver and passenger floor vents 32, 38. Similarly, the user can operate the non-defrost controls 54 to control distribution of conditioned air between the panel vents 30, 34, 36, 40 and the driver and passenger floor vents 32, 38.

Referring again to FIG. 2, the interface 24 includes an A/C input control 56, a MAX input control 58, and a recirculate input control 60. The user can operate the A/C input control 56 to switch the climate control system 26 between a cooling mode and a non-cooling mode. Similarly, the user can operate the MAX input control 58 to provide a maximum air cooling setting of the climate control system 26. The climate control system 26 can use the maximum air cooling setting to cool the cabin compartment 14 at the greatest rate that the climate control system 26 can provide. Also, the maximum air setting may be used to circulate air from the cabin compartment 14, through the climate control system 26, and returned to the cabin compartment 14 through one or more of the air vents 30, 32, 34, 36, 38, 40, 42. Furthermore, the user can operate the recirculate input control 60 to control recirculation of air in the cabin compartment 14 of the vehicle 12.

As illustrated in FIG. 3, the system 10 includes a seat occupancy sensor 62 at the passenger-side area 18 of the cabin compartment 14. The seat occupancy sensor 62 may be an occupant classification sensor (OCS) that senses one or more parameters for determining whether the seat 22 in the passenger-side area 18 is occupied. For example, the seat occupancy sensor 62 may be disposed within the passenger seat 22 to sense occupancy of the passenger seat 22. In operation, the seat occupancy sensor 62 senses size, weight, and/or position of a person or object in the passenger-side area 18 for determining whether a passenger in the vehicle 12 is occupying the passenger seat 22 in the passenger-side area 18. The seat occupancy sensor 62 may include an accelerometer, a piezo electric sensor, a piezo resistive sensor, a charged-coupled device, and/or a series of photodiodes to sense the size, weight, and/or position of the person or object. In addition, the seat occupancy sensor 62 may sense the size and/or position of the person or object using infrared sensing, visual image sensing, ultrasonic sensing, radar sensing, active electro-magnetic wave-ranging sensing, lidar-based sensing, or a combination thereof depending on the configuration of the system 10.

With reference to FIG. 3, the seat occupancy sensor 62 generates a sensor signal 64 based on sensing the size, the weight, and/or the position of the person or object in the passenger-side area 18. The sensor signal 64 is embedded or encoded with information that indicates occupancy of the seat 22 in the passenger-side area 18. For example, the sensor signal 64 may have information indicating whether a person is sitting on the passenger seat 22 in the vehicle 12. The seat occupancy sensor 62 of FIG. 3 is shown transmitting the sensor signal 64 along communication path 66. However, the seat occupancy sensor 62 may transmit the sensor signal 64 along another communication path, such as communication path 68, depending on the configuration of the system 10.

As shown in FIG. 3, the system 10 may include a temperature sensor 70 in the cabin compartment 14, such as in the driver-side area 16 of the vehicle 12. In operation, the temperature sensor 70 senses a temperature in the cabin compartment 14. For example, the temperature sensor 70 may sense the temperature in the cabin compartment 14 when an ignition of the vehicle 12 transitions from an off mode to a start mode. In another example, the temperature sensor 70 may sense the temperature in the cabin compartment 14 when one of the controls 44, 46, 48, 50, 52, 54, 56, 58, 60 of the interface 24 is adjusted, such as by the user of the interface 24. Based on the temperature sensed in the cabin compartment 14, the temperature sensor 70 generates a temperature signal 72. The temperature signal 72 is embedded or encoded with information indicating the temperature in the cabin compartment 14. For example, the temperature signal 72 may indicate a temperature of seventy-eight degrees Fahrenheit in the cabin compartment 14. The temperature sensor 70 of FIG. 3 is shown transmitting the temperature signal 72 along communication path 66. However, the temperature sensor 70 may transmit the temperature signal 72 along another communication path, such as communication path 68, depending on the configuration of the system 10.

As illustrated in FIG. 3, the climate control system 26 can include a fan 74, a cooling system 76, and a heating system 78. The fan 74 moves or propels air between the climate control system 26 and the cabin compartment 14 of the vehicle 12. More specifically, the fan 74 moves conditioned air from the climate control system 26 to the driver-side and passenger-side areas 16, 18 through one or more air vents 30, 32, 34, 36, 38, 40, 42.

The cooling system 76 provides cooled air to the cabin compartment 14 while the heating system 78 provides heated air to the cabin compartment 14. Heated air and cooled air from the climate control system 26 may be referred to as conditioned air. The cooling system 76 may include a compressor, evaporator, and refrigerant to cool air for the climate control system 26. The cooling system 76 operates when the climate control system 36 in the cooling mode, such as when a user operates the MAX input control 58 to obtain the maximum air cooling setting. Furthermore, the heating system 78 may include a heater core where air flows across the heater core to heat air for the climate control system 26. In operation, the fan 74 moves conditioned air from the cooling or heating systems 76, 78, through the air ducts 28, and into the cabin compartment 14 to facilitate temperature control in the cabin compartment 14.

As shown in FIG. 3, the system 10 includes at least one computer-based controller 80 or some other type of programmable logic device to control various components in the vehicle 12. The controller 80 of FIG. 3 is shown as a combination of a vehicle system controller (VSC) and a powertrain control module (PCM), which is hereinafter referenced as a “VSC” having reference numeral 82. However, the controller 80 may include a climate control module 84, the VSC 82, or a combination of the VSC 82 and the climate control module 84 depending on the configuration of the system 10. The controller 80 may be a single hardware device, include multiple controllers in the form of multiple hardware devices, or include multiple software controllers within one or more hardware devices.

As shown in FIG. 3, the controller 80 includes a processor 86, such as an electronic integrated circuit or microprocessor. The processor 86 operates to execute a set of software instructions 88, a computer program, and/or an algorithm of the system 10.

Referring again to FIG. 3, the system 10 includes a computer-readable storage medium 90 (hereinafter “memory”) to store the software instructions 88, a computer program, and/or algorithm embedded or encoded with the method. In addition to storing the software instructions 88, computer program, and/or algorithm, the memory 90 can store data or information about the various operating conditions or components in the vehicle 12 to implement the method. For example, the memory 90 can store the temperature settings for the driver-side and passenger-side areas 16, 18 of the vehicle 12. In such an example, the passenger-side temperature setting may be stored in the memory 90 as a temperature setting last selected for the passenger-side area 18.

The memory 90 can be part of the VSC 82 as shown in FIG. 1. However, the memory 90 may be positioned in any suitable portion or portions in the vehicle 12 accessible to the controller 80. For example, the memory 90 may be positioned in the climate control module 84, the VSC 82, or a combination of the climate control module 84 and the VSC 82.

As shown in FIG. 3, the VSC 82 may control the climate control system 26, the climate control module 84, or both the climate control system 26 and the climate control module 84 through a communications bus or vehicle data bus (hereinafter “data bus”). The data bus 92 is in communication with various components of the vehicle 12 including one or more controllers of the system 10, such as the VSC 82 and the climate control module 84 as illustrated in FIG. 3. The data bus 92 may be implemented as a controller area network (CAN), a local interconnect network (LIN), or any such suitable data-communication link that can transfer data between the controller 80 and other devices in the vehicle 12.

In operation, the controller 80 receives and processes the sensor signal 64 to determine the passenger seat occupancy at the passenger-side area 18 of the cabin compartment 14. In addition, the controller 80 can receive and process the temperature signal 72 that has information related to the temperature in the driver-side area 16 to determine the temperature in the passenger-side area 18. Based on the passenger seat occupancy, the temperature in the passenger-side area 18, or a combination thereof, the controller 80 executes the software instructions 88 stored in the memory 90 to control the climate control system 26 of the vehicle 12. More specifically, the controller 80 generates at least one control signal 94 to control the climate control system 26 of the vehicle 12.

When the passenger-side area 18 is unoccupied, the controller 80 generates the control signal 94 such that the climate control system 26 distributes conditioned air according to the driver-side temperature setting to both the driver-side and passenger-side areas 16, 18. For example, the controller 80 may change the mode of the climate control system 26 from the dual-zone mode to the single-zone mode when the controller 80 determines that the passenger-side area 18 is unoccupied. In operation, the climate control system 26 can distribute conditioned air to the passenger-side area 18 until the controller 80 determines that the temperature sensor 70 has sensed a temperature within a threshold value of the driver-side temperature setting and so long as the passenger-side area 18 is unoccupied. For example, the threshold value may be two degrees Fahrenheit.

The controller 80 of FIG. 3 is shown transmitting the control signal 94 along communication path 96 from the VSC 82 to the data bus 92. However, the controller 80 may transmit the control signal 94 along another communication path, such as communication path 98 to the climate control system 26, depending on the configuration of the system 10. For example, the controller 80 may transmit the control signal 94 along communication path 98 if the climate control system 26 is the controller 80.

When the controller 80 determines that the passenger-side area 18 is occupied by a passenger in the vehicle 12, the controller 80 can change the climate control system 26 from the single-zone mode to the dual-zone mode. In the dual-zone mode, the driver-side area 16 receives conditioned air from the climate control system 26 based on the driver-side temperature setting while the passenger-side area 18 receives conditioned air based on the passenger-side temperature setting.

To distribute conditioned air according to the driver-side temperature setting to both the driver-side and passenger-side areas 16, 18, the controller 80 may change the passenger-side temperature setting to the driver-side temperature setting. Changing the passenger-side temperature setting to the driver-side temperature setting allows the climate control system 26 to distribute air to the cabin compartment 14 independent of the passenger-side temperature setting. Thus, the controller 80 can control the climate control system 26 to distribute air at a single temperature to both the driver-side and passenger-side areas 16, 18. Using the climate control system 26 to distribute conditioned air at the single temperature facilitates achieving an air temperature at both the driver-side and passenger-side areas 16, 18 according to the driver-side temperature setting. Thus, the controller 80 may control the climate control system 26 to be in the single-zone mode to achieve a substantially similar temperature in both the driver-side and passenger-side areas 16, 18 of the vehicle 12.

The controller 80, such as the climate control module 84, can control the climate control system 26 to distribute air conditioned air to both the driver-side and passenger-side areas 16, 18 when a person selects the maximum air setting. The person can select the maximum air setting using the MAX input control 58 on the interface 24. When the maximum air setting is selected, the temperature of the conditioned air distributed to the cabin compartment 14 is based on the maximum air setting, such as a maximum cooling setting of the climate control system 26. The controller 80 can provide the highest level of cooled air to the cabin compartment 14 by changing the temperature settings of the driver-side and passenger-side temperature settings to the maximum air setting.

With reference to FIG. 4, a flowchart diagram 100 is provided to illustrate a method of controlling temperature in an automotive vehicle having a driver-side area and a passenger-side area. Controlling the temperature in the vehicle can reduce or minimize energy usage of the vehicle. Reducing energy usage can include reducing fuel consumed by the vehicle, reducing electric energy used by the vehicle, or a combination thereof depending on the type of vehicle. In addition to the steps shown in FIG. 4, a programmable logic device, such as the controller 80, may be programmed with additional steps to provide additional functionality.

Referring again to FIG. 4, the vehicle 12 and its components illustrated in FIGS. 1-3 are referenced throughout the discussion of the method to facilitate understanding of various aspects of the present invention. The method of controlling temperature in the vehicle 12 may be implemented through a computer algorithm, machine executable code, or software instructions 88 programmed into a suitable programmable logic device(s) of the vehicle 12, such as the VSC 82, the climate control module 84, other controller in the vehicle 12, or a combination thereof. Although the various steps shown in the flowchart diagram 100 appear to occur in a chronological sequence, at least some of the steps may occur in a different order, and some steps may be performed concurrently or not at all.

At block 102 of flowchart diagram 100, an ignition state of the vehicle 12 transitions from the off mode to the start mode. The VSC 82 can determine when the ignition of the vehicle 12 transitions to the start mode. Once the ignition transitions to the start mode decision, the controller 80 may perform decision block 104.

At decision block 104, it is determined whether the previous state of the climate control system 26 was the dual-zone mode. The VSC 82 can determine whether the climate control system 26 was last in the dual-zone mode based on the mode of the climate control system 26 when the vehicle 12 was switched off. If the previous state of the climate control system 26 was not the dual-zone mode, then decision block 106 occurs. However, if the previous state of the climate control system 26 was the dual-zone mode, then block 108 occurs.

At decision block 106, the previous power state of the climate control system 26 is determined. The previous power state can be either in the on mode or off mode. The user can operate the power input control 48 to switch the climate control system 26 between the on and off modes. The controller 80 can determine the previous power state of the climate control system 26. For example, the VSC 82 may determine the previous power state of the climate control system 26 based on input from the power input control 48. If the previous power state of the climate control system 26 was the off mode, then the climate control system 26 was not previously distributing conditioned air to the cabin compartment 14 and block 110 occurs. However, if the previous state of the climate control system 26 was not the off mode, then the climate control system 26 was last in the single-zone mode and block 112 occurs.

At block 108 of flowchart diagram 100, the climate control system 26 operates in dual-zone mode and decision block 114 occurs.

At block 110, the climate control system 26 is in the off mode until the vehicle 12 is switched off or a user uses the power input control 48 of the interface 24 to switch the climate control system 26 from the off mode to the on mode. When the climate control system 26 is in the off mode, conditioned air is not distributed from the climate control system 26 to the cabin compartment 14.

At block 112, the climate control system 26 is in the single-zone mode until the vehicle 12 is switched off or a user presses the passenger input control 46 of the interface 24 to switch the climate control system 26 from the single-zone mode to the dual-zone mode.

At decision block 114, it is determined whether a passenger setpoint adjustment has occurred. For example, a passenger setpoint adjustment can occur when a user operates the passenger input control 46 to input or select a passenger-side temperature setting for the passenger-side area 18. The VSC 82, the climate control module 84, or a combination thereof can determine whether a passenger has selected or modified a passenger-side temperature setting for the climate control system 26. If a passenger setpoint adjustment has not occurred, then decision block 116 occurs. However, if a passenger setpoint adjustment has occurred, then the climate control system 26 continues to operate in the dual-zone mode and block 122 occurs.

At decision block 116, it is determined whether a maximum air setting or a single-zone mode setting has been selected for the climate control system 26. The VSC 82, the climate control module 84, or a combination thereof can determine whether a maximum air setting or a single-zone mode setting has been selected.

Referring again to block 116, a user may operate the MAX input control 58 of the interface 24 to select a maximum air cooling setting to cool the cabin compartment 14. In one configuration, as shown in FIG. 4, the climate control system 26 distributes conditioned air according to the maximum air setting to both the driver-side and passenger-side areas 16, 18 when the maximum air setting has been selected. If the maximum air setting has been selected, then the climate control system 26 switches to the single-zone mode and block 112 occurs. However, if neither the maximum air setting nor the single-zone mode setting has been selected, then decision block 118 occurs. However, selection of the maximum air setting may not switch the climate control system 26 from the dual-zone mode to the single-zone mode in another configuration. In such another configuration, the climate control system 26 enters the single-zone mode and block 112 occurs only when the single-zone mode setting is selected. For example, a user may operate the passenger input control 46 to select the single-zone mode setting for the climate control system 26. In such another configuration, if the single-zone mode setting has been selected, then the climate control system 26 switches to the single-zone mode and block 112 occurs. However, if the single-zone mode setting has not been selected, then decision block 118 occurs.

At decision block 118, it is determined whether the vehicle 12 has operated above a predetermined speed for at least a predetermined amount of time. Both the predetermined speed and the predetermined amount of time can be stored in the memory 90. The predetermined speed is shown as three kilometers per hour in FIG. 4; however, the predetermined speed can be any suitable speed to establish movement of the vehicle 12. In addition, the predetermined amount of time is shown as twenty seconds; however, the predetermined amount of time can be any suitable time to establish that the vehicle 12 is being driven with a passenger in the passenger-side area 18.

When the vehicle 12 has operated above the predetermined speed for at least the predetermined amount of time, then the controller 80 can determine the occupancy of the passenger seat 22 in the passenger-side area 18. If the vehicle 12 has operated above the predetermined speed for at least the predetermined amount of time, then the controller 80 determines the passenger seat occupancy in decision block 120. However, if the vehicle 12 has not operated above the predetermined speed for at least the predetermined amount of time, then block 108 occurs. The VSC 82, the climate control module 84, or a combination thereof can determine whether the vehicle 12 has operated above the predetermined speed for at least the predetermined amount of time.

At decision block 120, it is determined whether the passenger-side area 18 is occupied. For example, an occupant classification sensor (OCS) at the seat 22 in the passenger-side area 18 may generate the sensor signal 64. Based on the sensor signal 64, the controller 80 can determine the passenger seat occupancy at the passenger-side area 18. If the passenger-side area 18 is determined to be occupied, then block 122 occurs. However, if the passenger-side area 18 is determined to be unoccupied, then block 112 occurs.

At block 122, the climate control system 26 is in the dual-zone mode until the vehicle 12 is switched off or a user presses the passenger input control 46 of the interface 24 to switch the climate control system 26 from the dual-zone mode to the single-zone mode.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for controlling temperature in an automotive vehicle having a driver-side area, a front passenger-side area, and a climate control system with at least one interface to allow a user to select a driver-side temperature setting and a passenger-side temperature setting, the system comprising:
a seat occupancy sensor at the front passenger-side area of the vehicle for generating a sensor signal indicative of passenger seat occupancy in the passenger-side area; and
at least one computer-based controller configured to respond to the sensor signal by executing software instructions stored in computer memory to control the climate control system of the vehicle;
wherein the climate control system distributes conditioned air according to the driver-side temperature setting to both the driver-side and passenger-side areas when the passenger-side area is unoccupied.

2. The system of claim 1 wherein the driver-side temperature setting is stored in the memory, the controller being configured to change the passenger-side temperature setting to the driver-side temperature setting to control the climate control system to distribute air at a single temperature to both the driver-side and passenger-side areas in an effort to achieve the driver-side temperature setting at both the driver-side and passenger-side areas.

3. The system of claim 1 wherein the climate control system controls temperature distribution of conditioned air between the driver-side and passenger-side areas to distribute conditioned air according to the driver-side temperature setting to both the driver-side and passenger-side areas when the passenger-side area is unoccupied.

4. The system of claim 1 wherein the controller controls the climate control system to distribute conditioned air to the passenger-side area independent of the passenger-side temperature setting when the controller determines that the passenger-side area is unoccupied.

5. The system of claim 1 wherein the climate control system includes a temperature sensor in electrical communication with the controller for generating a temperature signal indicative of a temperature in the vehicle, the climate control system distributing conditioned air to the passenger-side area until the controller determines that the temperature sensor has sensed a temperature within a threshold value of the driver-side temperature setting and so long as the passenger-side area is unoccupied.

6. The system of claim 1 wherein the controller determines the passenger seat occupancy when the automotive vehicle has operated above the predetermined speed for at least the predetermined amount of time.

7. The system of claim 6 wherein the controller determines whether the automotive vehicle has operated above the predetermined speed for at least the predetermined amount of time when the controller determines that the passenger-side temperature setting has not been adjusted since an ignition start of the automotive vehicle.

8. The system of claim 1 wherein the interface for the climate control system is configured to allow the user to select a maximum air setting, the climate control system distributing conditioned air according to the maximum air setting to both the driver-side and passenger-side areas when the user selects the maximum air setting.

9. The system of claim 1 wherein the controller controlling the climate control system to distribute conditioned air according to the driver-side temperature setting to both the driver-side and passenger-side areas when the passenger-side temperature setting is less than the driver-side temperature setting.

10. The system of claim 1 wherein the climate control system has a single-zone mode and a dual-zone mode, the controller changing the climate control system from the dual-zone mode to the single-zone mode when the controller determines that the passenger-side area is unoccupied.

11. The system of claim 10 wherein the controller changing the climate control system from the single-zone mode to the dual-zone mode when the controller determines that the passenger-side area is occupied.

12. The system of claim 1 wherein the controller controls the climate control system to distribute conditioned air to the driver-side area according to the driver-side temperature setting and other air to the passenger-side area according to the passenger-side temperature setting when the controller determines that the passenger-side area is occupied by a passenger in the vehicle.

13. The system of claim 12 wherein the passenger-side temperature setting is stored in the computer memory as a temperature setting last selected for the passenger-side area.

14. The system of claim 1 wherein the seat occupancy sensor includes an occupant classification sensor to sense whether a seat in the passenger-side area is occupied and to generate the sensor signal.

15. A system for controlling temperature in an automotive vehicle having a cabin compartment with a driver-side area and a front passenger-side area, the system comprising:
a climate control system including at least one interface to allow a user to select a driver-side temperature setting for the driver-side area of the vehicle and a passenger-side temperature setting for the passenger-side area of the vehicle;
a temperature sensor in the cabin compartment of the vehicle, the temperature sensor sensing a temperature in the cabin compartment and generating a temperature signal indicative of the temperature in the cabin compartment;
a seat occupancy sensor at the front passenger-side area of the vehicle, the seat occupancy sensor generating a sensor signal indicative of passenger seat occupancy in the passenger-side area; and
at least one computer-based controller including a processor operable to execute software instructions, a computer memory operable to store software instructions accessible by the processor, and a set of software instructions stored in the memory to determine the passenger seat occupancy based on the sensor signal, to determine the temperature in the passenger-side area based on the temperature signal, and to generate at least one control signal based on the passenger seat occupancy and the temperature signal to control the climate control system of the vehicle;
wherein the climate control system distributes conditioned air according to the driver-side temperature setting to both the driver-side and passenger-side areas so long as the passenger seat occupancy indicates that the passenger-side area of the vehicle is unoccupied and until the controller determines that the temperature sensor has sensed a temperature within a threshold value of the driver-side temperature setting.

16. The system of claim 15 wherein the controller is configured to determine whether the automotive vehicle has operated above a predetermined speed for at least a predetermined amount of time, the controller determining the passenger seat occupancy in the passenger-side area when the automotive vehicle has operated above the predetermined speed for at least the predetermined amount of time.

17. The system of claim 15 wherein the interface for the climate control system is configured to allow the user to select a maximum air setting, the climate control system distributing conditioned air according to the maximum air setting to both the driver-side and passenger-side areas when the user selects the maximum air setting.

18. A method of controlling temperature in an automotive vehicle having a driver-side area and a front passenger-side area, the method comprising:
receiving a sensor signal indicative of passenger seat occupancy in the passenger-side area; and
determining the passenger seat occupancy based on the sensor signal; and
generating at least one control signal based on the passenger seat occupancy to control distribution of conditioned air according to a driver-side temperature setting to both the driver-side and passenger-side areas of the vehicle when the passenger seat occupancy indicates that the passenger-side area is unoccupied.

19. The method of claim 18 further including determining whether the automotive vehicle has operated above a predetermined speed for at least a predetermined amount of time and determining the passenger seat occupancy in the passenger-side area if the automotive vehicle has operated above the predetermined speed for at least the predetermined amount of time.

20. The method of claim 18 further including determining whether a maximum air setting has been selected and distributing conditioned air according to the maximum air setting to both the driver-side and passenger-side areas if the maximum air setting has been selected.
